(19) United States
(12) Patent Application Publication
(10) Pub. No.: US 2026/0267439 A1
(43) Pub. Date: Sep. 10, 2026

(54) METHODS OF CONTROLLING TOUCH SENSITIVITY OF TOUCH DEVICE FOR ENHANCING POWER EFFICIENCY

(71) Applicant: NOVATEK Microelectronics Corp., Hsin-Chu (TW)

(72) Inventors: Chih Peng, Hsinchu City (TW); Hsin-Ting Chan, Taichung city (TW); Ding-Teng Shih, Hsinchu City (TW); Fan-Wei Kuo, Hsinchu County (TW)

(73) Assignee: NOVATEK Microelectronics Corp., Hsin-Chu (TW)

(21) Appl. No.: 19/071,772

(22) Filed: Mar. 6, 2025

(51) Int. Cl. G06F 3/041

(52) U.S. Cl. CPC G06F 3/04166

(57) ABSTRACT

A touch device includes a touch panel and a touch control circuit. A method of controlling touch sensitivity of the touch device includes the touch control circuit determining a location of a touch event on the touch panel, the touch control circuit defining a first area on the touch panel based on the location of the touch event, the location of the touch event being in the first area, and the touch control circuit reducing touch sensitivity of a second area on the touch panel outside the first area.

### BACKGROUND OF THE INVENTION

### 1. Field of the Invention

The invention relates to touch technology, and in particular, to methods of controlling touch sensitivity of a touch device for enhancing power efficiency.

### 2. Description of the Prior Art

The integration of touch technology in modern mobile devices represents a revolutionary shift in how humans interact with digital interfaces. Smartphones and tablets have embraced capacitive touchscreens as their primary input method, allowing users to directly manipulate on-screen elements through intuitive gestures such as tapping and swiping. This direct manipulation paradigm has significantly reduced the learning curve for users while enabling more natural and engaging interactions compared to traditional input methods such as keyboards and mice.

The pursuit of optimal user experience on the mobile devices leads to increase in both the display rates and touch scan rates. However, while reducing input lag and increasing precision of tracking user gestures, the increase in both the display rates and touch scan rates come with a significant trade-off in terms of power consumption and computational load, placing additional strain on the battery life of the mobile devices, creating a challenge to balance between performance and power efficiency.

### SUMMARY OF THE INVENTION

According to an embodiment of the invention, a touch device includes a touch panel and a touch control circuit, and a method of controlling touch sensitivity of the touch device includes the touch control circuit determining a location of a touch event on the touch panel, the touch control circuit defining a first area on the touch panel based on the location of a touch event, the location of a touch event being in the first area, and the touch control circuit reducing touch sensitivity of a second area on the touch panel outside the first area.

According to another embodiment of the invention, a touch device includes a touch panel, a touch control circuit, a first key component, and a first temperature sensor, the first temperature sensor being disposed at the first key component. A method of controlling touch sensitivity of the touch device includes defining a first area based on at least the location of the first key component, the first key component being in the first area, the first temperature sensor monitoring a temperature of the first key component, and the touch control circuit selectively reducing touch sensitivity of the first area based on at least the temperature of the first key component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1A-1D show schematic diagrams of adaptive touch sensitivity schemes for use on a touch device according to various embodiments of the invention.

FIG. 2 is a block diagram of a touch device according to an embodiment of the invention.

FIG. 3 is schematic diagram of the touch control circuit and the touch panel in FIG. 2, according to an embodiment of the invention.

FIG. 4 is a flowchart of a method of controlling the touch sensitivity of the touch device in FIG. 2, according to an embodiment of the invention.

FIG. 5 shows a schematic diagram of an adaptive touch sensitivity scheme for use on the touch device in FIG. 2.

FIG. 6 is a flowchart of a method of controlling the touch sensitivity of the touch device in FIG. 2, according to another embodiment of the invention.

FIG. 7A and FIG. 7B show schematic diagrams of adaptive touch sensitivity schemes for use on the touch device in FIG. 2, according to 2 embodiments of the invention.

FIG. 8 is a flowchart of a method of controlling the touch sensitivity of the touch device in FIG. 2, according to another embodiment of the invention.

### DETAILED DESCRIPTION

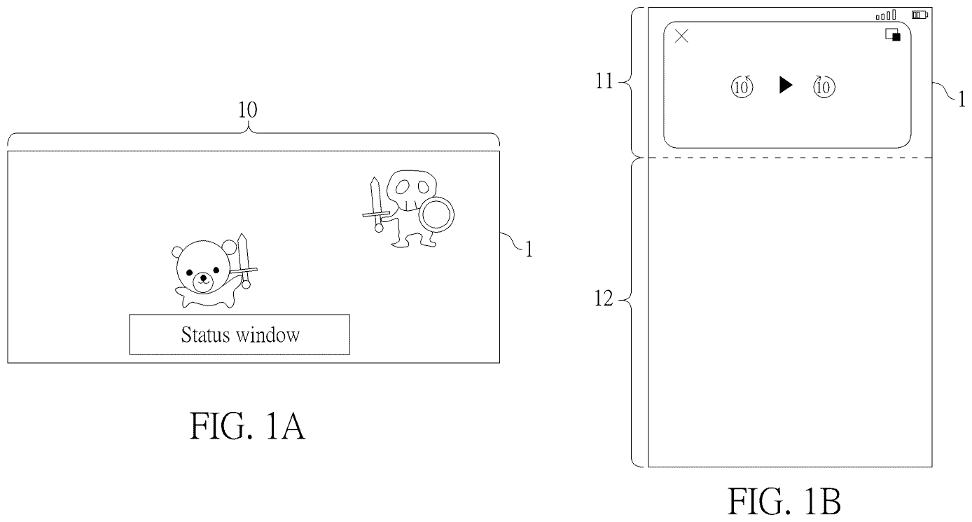

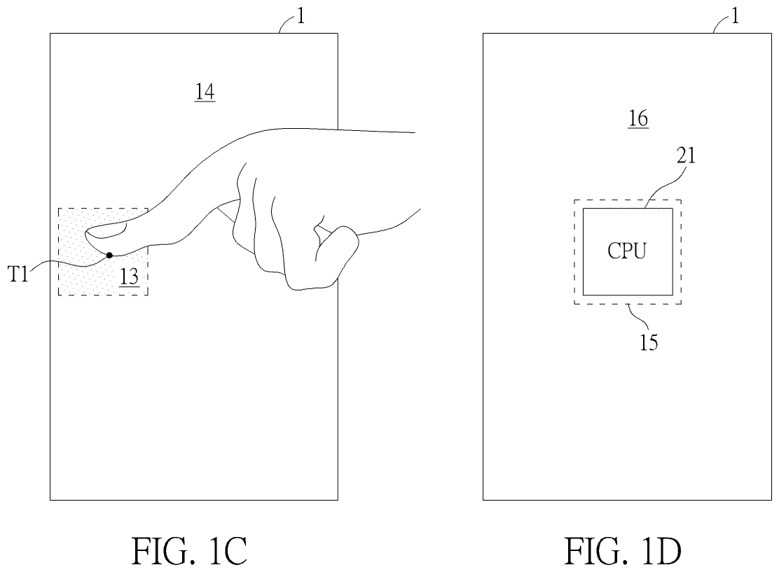

FIGS. 1A-1D show schematic diagrams of adaptive touch sensitivity schemes for use on a touch device according to various embodiments of the invention. The adaptive touch sensitivity schemes provide methods to dynamically adjust touch sensitivity of the touch device to optimize performance and power usage. Specifically, the touch device may define priority areas and power-saving areas on a touch panel 1 of the touch device based on application-specific characteristics, usage patterns, and/or temperature readings. The touch device may maintain high touch sensitivity of the priority areas to ensure optimal touch response while reducing touch sensitivity of the power-saving areas to conserve power. Consequently, the adaptive touch sensitivity schemes may be used for touch devices such as smartphones and tablets, where both touch responsiveness and battery life are crucial.

FIGS. 1A and 1B illustrate an adaptive touch sensitivity scheme for adjusting touch sensitivity based on the specific requirements and behaviors of different applications. FIG. 1A shows a full-screen video game application where the entire touch panel 1 is designated as a priority area 10. That is, the entire screen of the touch panel 1 is highly sensitive to touch inputs, which is crucial for gaming. The priority area 10 may display visual content such as the game environment, characters, and animations, while receiving user interactions essential for gameplay, such as selecting units, issuing commands, and managing resources. The high touch sensitivity across the priority area 10 ensures that the game responds quickly and accurately to user inputs, providing a seamless and immersive gaming experience.

FIG. 1B shows a video-sharing application where the entire touch panel 1 are divided into a power-saving area 11 and a priority area 12. The power-saving area 11 may be designed to display video content and anticipates fewer user interactions, such as only tap operations rather than swipe operations. As a result, the power-saving area 11 requires less touch sensitivity, conserving battery life while reducing power consumption. On the other hand, the priority area 12 may be designed to display text content and expect most user interactions, such as writing comments or using the soft keyboard for inputs. Therefore, the priority area 12 requires high touch sensitivity to ensure that user inputs are accurately and promptly registered. By differentiating the touch sensitivity based on the expected level of interaction, the touch device can provide a smooth user experience while optimizing power usage.

FIG. 1C illustrates another adaptive touch sensitivity scheme for adjusting touch sensitivity based on touch locations, prioritizing areas of the touch panel 1 that are actively being used, while conserving power in the unused areas. Initially, the touch panel 1 may be divided into predetermined areas. Upon detecting a touch input T1, the touch device may dynamically designate a predetermined area including the touch input T1 as the priority area 13, and designate the remaining area on the touch panel 1 as the power-saving area 14. The priority area 13 is given higher touch sensitivity to ensure that user interactions are accurately and promptly registered. The power-saving area 14 is assigned lower touch sensitivity to conserve power and extend battery life without compromising the overall user experience. The adaptive touch sensitivity scheme as illustrated in FIG. 1C can enhance user experience, increase power efficiency, while providing tailored touch sensibility for various tasks based on usage patterns.

FIG. 1D illustrates another adaptive touch sensitivity scheme for adjusting touch sensitivity based on temperature readings, maintaining normal touch sensitivity in areas of the touch panel 1 that are within a normal temperature range, while conserving power and reducing heat generation in overheated areas. Initially, the touch device may define a power-saving area (or thermal control area) 15 based on the location of a central processing unit (CPU) 21 of the touch device while designate the remaining area on the touch panel 1 as the priority area 16. Upon detecting that the CPU 21 is overheated, the touch device may lower the touch sensitivity in the power-saving area 15 to reduce heat generation and power consumption while maintaining the touch sensitivity in the priority area 16 to ensure touch responsiveness. The adaptive touch sensitivity scheme as illustrated in FIG. 1D can enhance user experience, increase power efficiency, while providing heat management of the critical areas on the display panel 1.

The touch sensitivity of different areas may be controlled by varying signal accumulation, scan rates, and/or scan methods. The signal accumulation may be implemented by gathering and integrating multiple touch signals over a period of time to enhance the detection and interpretation of touch inputs, thereby enhancing the accuracy by averaging out noise and ensuring that only deliberate touches are registered. The scan rate indicates how frequently the touch sensors are read in either scan method. The scan methods may be 2-dimensional (2D) scans, 1-dimensional (1D) scans, or no scan. In a 2D scan, the touch control circuit 24 scans the touch panel 1 to create a detailed grid of touch data points. In a 1D scan, the touch control circuit 24 scans either horizontal or vertical electrodes of the touch panel 1 to generate one data point per electrode, offering less detail but operating faster and using less power. For simplicity, the following discussion will focus on controlling touch sensitivity through varying scan rates. However, those skilled in the art would recognize that areas adopting higher scan rates could use 2D scans, while areas adopting lower scan rates could use 1D scans as alternatives.

This touch sensitivity may be adapted in several key scenarios. When a passive stylus touch is utilized, the touch sensitivity may be compensated for weaker touch signals from the passive stylus by increasing signal accumulation while reducing the scan rate, resulting in a boost in the signal-to-noise ratio (SNR). When a finger touch is utilized, since the signal strength of touch signals from the finger is typically sufficient, the touch sensitivity may be adapted by reducing signal accumulations while increasing the scan rates, leading to decreased SNR but achieving faster touch response times. In gaming mode scenarios, the touch sensitivity may be adjusted by increasing the 1D scan rate, which, while consuming more power, delivers the rapid touch response necessary for gaming performance. Additionally, during the power-saving sleep mode, the touch sensitivity may be adapted by reducing 1D scan rates to conserve energy, though this comes at the cost of slower touch response times. These trade-offs between sensitivity, response time, and power consumption illustrate the complex balance in the touchscreen design.

In some embodiments, a multi-area refresh scheme may be implemented alongside the adaptive touch sensitivity scheme to further optimize the performance and energy efficiency of the touch panel 1. The multi-area refresh scheme involves setting different refresh rates for various display areas on the touch panel 1. For example, an area that shows the video content may require higher refresh rates to ensure smooth visual presentation, while another area that displays text content may operate at lower refresh rates to conserve power.

The implementation of this multi-area refresh scheme may be independent of the adaptive touch sensitivity scheme. This means that the areas of the touch panel 1 having different refresh rates do not necessarily correspond to the areas having different scan rates. For instance, an area of the touch panel 1 may have a high refresh rate to display video content smoothly, while the same area may have a low scan rate if it does not require frequent touch inputs. Conversely, an area having frequent touch interactions, such as a control panel, may have a high scan rate but a lower refresh rate if the displayed content is relatively static. The adaptive touch sensitivity scheme and multi-area refresh scheme can enhances the overall user experience by maintaining high responsiveness where needed and conserving energy where possible, ultimately leading to a more efficient and effective touch device.

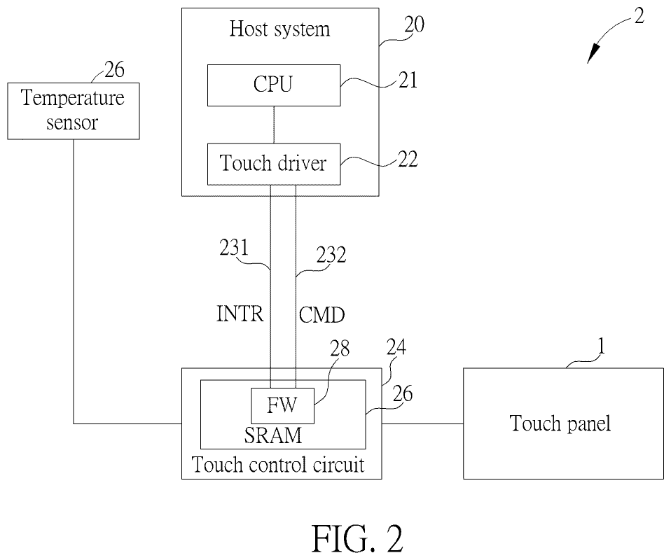

FIG. 2 is a block diagram of a touch device 2 according to an embodiment of the invention. The touch device 2 may be a smartphone, tablet, on-vehicle display device, digital drawing pads, touch display, interactive whiteboard, or other devices that incorporate the touch panel 1. The touch device 2 may include a host system 20, a touch control circuit 24, the touch panel 1, and a temperature sensor 26. The host system 20 may include a central processing unit (CPU) 21 and have a touch driver 22 installed in the host system 20. The temperature sensor 26 may be disposed at the CPU 21 or another key component (e.g., battery) of the touch device 2 to monitor the temperature thereof. Specifically, all or part of the temperature sensor 26 may be positioned above, below or beside the CPU 21. The touch control circuit 24 may include a static random access memory (SRAM) 26 having firmware (FW) 28 stored therein. The host system 20 may be coupled to the touch control circuit 24 via a line 231 and bus lines 232. The touch control circuit 24 may be further coupled to the temperature sensor 26 and the touch panel 1.

The host system 20 may include both software and hardware components, such as an operating system and a processor, so as to manage the functionalities of the touch device 2. The touch driver 22 may be a software component bridging between the operating system and the touch control circuit 24, translating the operating system's instructions into specific commands CMD that the touch control circuit 24 can interpret and execute, thereby enabling the touch operations. The firmware 28 may instruct the touch control circuit 24 to perform scan operations on the touch panel 1. The bus lines 232 may be inter-integrated circuit (I2C) or serial peripheral interface (SPI) bus lines transmitting commands CMD between the host system 20 and the touch control circuit 24. The touch control circuit 24 may include a hardware component to detect touch inputs on the touch panel 1, identifying the occurrence and precise location of each touch. Further, the touch control circuit 24 may control the scan methods or scan rates for different areas of the touch panel 1, realizing the adaptive touch sensitivity scheme. Furthermore, the touch control circuit 24 may transmit the locations of touch inputs on the touch panel 1 via an interrupt signal INTR on the line 231 to the host system 20, allowing the touch device 2 to respond appropriately to the touch inputs.

The firmware 28 may define the priority areas and the power-saving areas based on application information from the host system 20, the touch locations from the touch panel 1, and/or the temperature data from the temperature sensor 26, and configure scan rates of the priority areas and the power-saving areas. The touch control circuit 24 may then adjust the sensitivity levels across the touch panel 1 according to the scan rates.

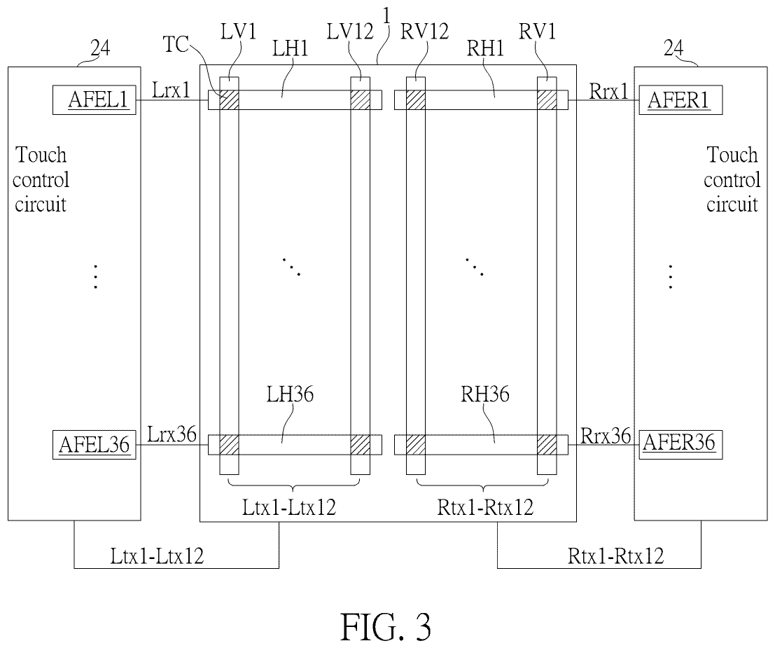

FIG. 3 is schematic diagram of the touch control circuit 24 and the touch panel 1, according to an embodiment of the invention. The touch control circuit 24 may be either a touch display driver integrated circuit (TDDI) integrated with the touch panel 1, or an external touch driver integrated circuit (IC) separated from the display panel 1. For simplicity, the following discussion will focus on the TDDI as the touch control circuit 24.

The touch panel 1 may be divided into left and right halves. The left half of the touch control circuit 24 may include, but not limited to, 12 vertical electrodes (LV1 to LV12), and the right half of the touch control circuit 24 may include, but not limited to, 12 vertical electrodes (RV1 to RV12). Each of the vertical electrodes LV1 to LV12 may intersect with, but is not limited to, 36 horizontal electrodes (LH1 to LH36), forming 36 touch sensors TC at the crossover points. Similarly, each of the vertical electrodes RV1 to RV12 may intersect with, but is not limited to, 36 horizontal electrodes (RH1 to RH36), forming 36 touch sensors TC at the crossover points.

The touch control circuit 24 may be coupled to the vertical electrodes LV1 to LV12 and RV1 to RV12 to transmit stimuli signals Ltx1 to Ltx12 and Rtx1 to Rtx12, respectively. The touch control circuit 24 may be further coupled to the horizontal electrodes LH1 to LH36 and RH1 to RH36 to retrieve response signals Lrx1 to Lrx36 and Rrx1 to Rrx36, respectively. The response signals Lrx1 to Lrx36 and Rrx1 to Rrx36 may contain capacitance readings of the touch cells TC.

The touch control circuit 24 may include, but is not limited to, 36 analog front ends (AFEL1 to AFEL36), and 36 analog front ends (AFER1 to AFER36). The analog front ends AFEL1 to AFEL36 may be coupled to the left half of the touch control circuit 24. In some embodiments, each analog front end may include an analog-to-digital converter (ADC) coupled to a specific horizontal electrode on the left half of the touch control circuit 24, converting analog signal from a touch sensor into digital data. For example, the analog front end AFEL1 may be coupled to the horizontal electrode LH1, and the analog front end AFEL36 may be coupled to the horizontal electrode LH36.

Likewise, the analog front ends AFER1 to AFER36 may be coupled to the right half of the touch control circuit 24, and each analog front end may be coupled to a specific horizontal electrode on the right half of the touch control circuit 24. For example, the analog front end AFER1 may be coupled to the horizontal electrode RH1, and the analog front end AFER36 may be coupled to the horizontal electrode RH36.

During a 2D scan, the touch control circuit 24 may send a stimuli signal to a selected vertical electrode, and in response, the 36 analog front ends may read 36 capacitance readings from the horizontal electrodes that intersect with the selected vertical electrode. If a finger touches a touch sensor TC, the local electrostatic field would be disrupted at the point of contact, changing the capacitance of the specific touch sensor TC being touched. The touch control circuit 24 may process the 36 capacitance readings to identify a touch point, convert the location of the touch point into coordinates on the touch panel 1, and transmit the coordinates of the touch point to the host system 20 for subsequent processes. The touch control circuit 24 may perform the 2D scans to generate the coordinates of all touch inputs, and the host system 20 may interpret the touch inputs and respond accordingly. The 2D scan process enables accurate and responsive touch detection, ensuring smooth interaction on the touch panel 1.

During a 1D scan, the touch control circuit 24 may send a stimuli signal to a selected vertical or horizontal electrode, and an analog front end may measure the self-capacitance of the selected vertical or horizontal electrode to obtain 1 capacitance reading. If a finger touches a touch sensor TC, the local electrostatic field would be disrupted, altering the self-capacitance of a vertical or horizontal electrode forming the touch sensor TC. The touch control circuit 24 may detect a tap (or “click”) event based on the capacitance reading without determining the exact position, allowing for rapid detection of touch inputs without the computational overhead required for precise position determination. The touch control circuit 24 may transmit the approximate locations of one or more tap events, or just the tap events themselves, to the host system 20. The host system 20 may then match the approximate locations or the tap events with predefined interactive elements or gesture patterns to determine the intended user action.

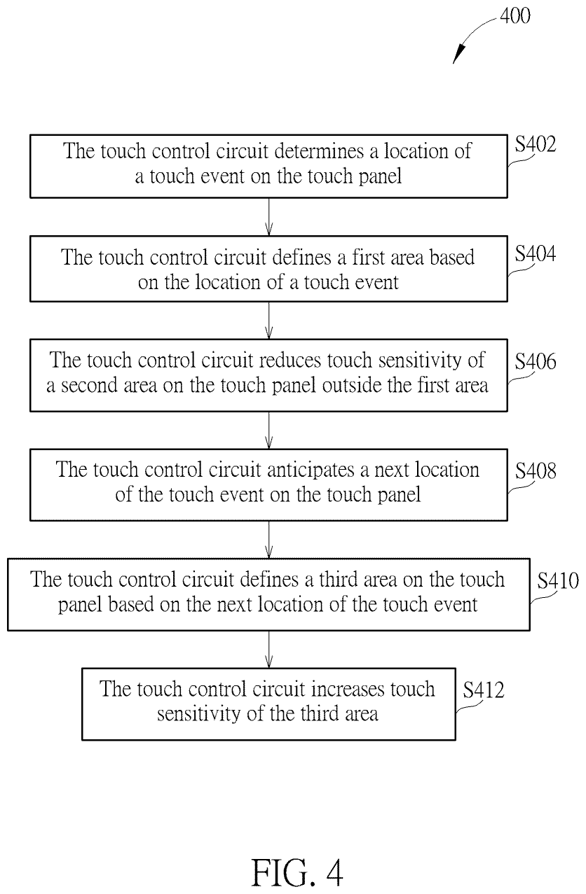

FIG. 4 is a flowchart of a method 400 of controlling the touch sensitivity of the touch device 2, according to an embodiment of the invention. The method 400 includes Steps S402 to S412 to control the touch sensitivity of different areas on the touch panel 1 based on the locations of touch inputs. Any reasonable step change or adjustment is within the scope of the present disclosure. Steps S402 to S412 are detailed as follows:
Step S402: The touch control circuit 24 determines a location of a touch event on the touch panel 1;
Step S404: The touch control circuit 24 defines a first area on the touch panel 1 based on the location of a touch event, the location of a touch event being in the first area;
Step S406: The touch control circuit 24 reduces touch sensitivity of a second area on the touch panel 1 outside the first area;
Step S408: The touch control circuit 24 anticipates a next location of the touch event on the touch panel;
Step S410: The touch control circuit 24 defines a third area on the touch panel based on the next location of the touch event;
Step S412: The touch control circuit 24 increases touch sensitivity of the third area.

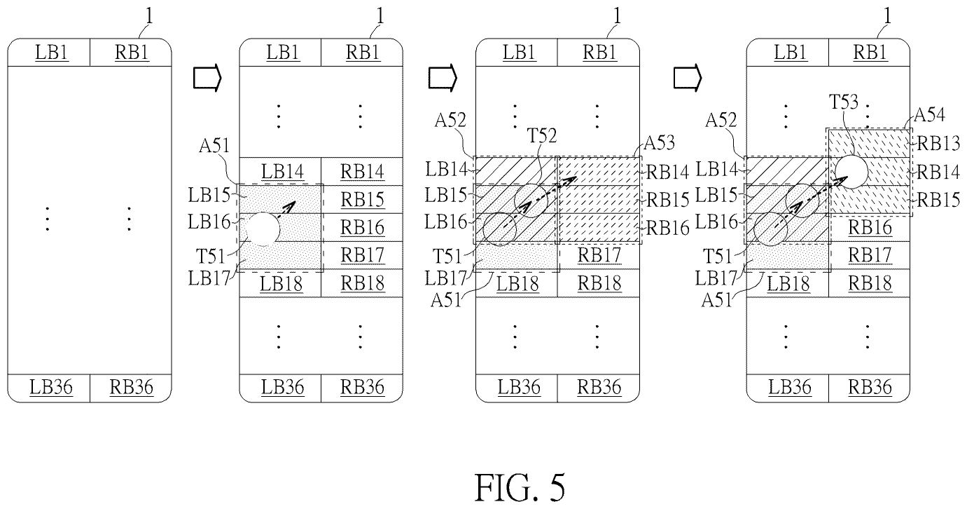

The method 400 is now explained with reference to FIG. 5. FIG. 5 shows schematic diagrams of the method 400 for use on the touch device 2. Initially, the touch panel 1 is divided into blocks LB1 to LB36 and RB1 to RB36, all being scanned using 2D scans at a low scan rate, such as 30 Hz. The locations and dimensions of the blocks LB1 to LB36 and RB1 to RB36 may be stored in memory of the touch control circuit 24.

Next, a touch event is detected. The touch control circuit 24 determines the exact location T51 of the touch event (S402), and defines an area A51 based on the location T51 of the touch event (S404). In the embodiment, since the location T51 of the touch event occurs between the blocks LB16 and LB17, the touch control circuit 24 designates the blocks LB15 to LB17 as the priority area A51. The touch control circuit 24 may set higher touch sensitivity for the priority area A51 compared to the remaining area (blocks LB1 to LB14, LB18 to LB36, and RB1 to RB36) on the touch panel 1 outside the priority area A51 (S406). For example, the touch control circuit 24 may perform a 2D scan on the priority area A51 at 120 Hz, while scanning the remaining area at 60 Hz. Consequently, the touch control circuit 24 may alternate between a fully scanned frame and a partially scanned frame at a 1:1 ratio. In the partially scanned frame, the touch control circuit 24 may activate analog front-ends coupled to the priority area A51 while deactivating analog front-ends coupled to the remaining area. For example, the touch control circuit 24 may activate analog front-ends AFEL15 to AFEL17 coupled to the blocks LB15 to LB17 in the priority area A51 while deactivating analog front-ends AFEL1 to AFEL14, AFEL18 to AFEL36, and AFER1 to AFER36 coupled to the blocks LB1 to LB14, LB18 to LB36, and RB1 to RB36 in the remaining area.

Next, a subsequent location T52 of the touch event is detected between the blocks LB15 and LB16. As a result, the touch control circuit 24 designates the blocks LB14 to LB16 as the priority area A52 and increase the touch sensitivity thereof. The touch control circuit 24 may keep the priority area A51 active for a predetermined numbers of frames, such as 3 frames. Further, the touch control circuit 24 may anticipates that a next location of the touch event occurs in the blocks RB14 to RB16 based on the moving direction of the touch event (S408), thus setting the blocks RB14 to RB16 as the priority area A53. In some embodiments, the touch control circuit 24 may determine the moving direction of the touch event based on the locations T51 and T52. The touch control circuit 24 may then increase the touch sensitivity thereof (S412). Therefore, the touch control circuit 24 may set higher touch sensitivity for the priority areas A51 to A53 compared to the remaining area (blocks LB1 to LB13, LB18 to LB36, RB1 to RB13, and RB17 to RB36) on the touch panel 1. The touch control circuit 24 may perform a 2D scan on the priority areas A51 to A53 at 120 Hz, while scanning the remaining area at 60 Hz. Consequently, the touch control circuit 24 may alternate between a fully scanned frame and a partially scanned frame at a 1:1 ratio. In the partially scanned frame, the touch control circuit 24 may activate analog front-ends coupled to the priority areas A51 to A53 while deactivating analog front-ends coupled to the remaining area. For example, the touch control circuit 24 may activate analog front-ends AFEL14 to AFEL17 and AFER14 to AFER16 while deactivating analog front-ends AFEL1 to AFEL13, AFEL18 to AFEL36, AFER1 to AFER13, and AFER17 to AFER36.

A subsequent location T53 of the touch event is then detected between the blocks RB14 and RB15. As a result, the touch control circuit 24 designates the blocks RB13 to LB15 as the priority area A54 and increase the touch sensitivity thereof. The priority area A51 is removed since no touch input is detected for the predetermined number of frames, and the priority area A53 is removed upon detection of the location T53. Therefore, the touch control circuit 24 may set higher touch sensitivity for the priority areas A52 and A54 compared to the remaining area (blocks LB1 to LB13, LB17 to LB36, RB1 to RB12, and RB16 to RB36) on the touch panel 1. The touch control circuit 24 may perform a 2D scan on the priority areas A52 and A54 at 120 Hz, while scanning the remaining area at 60 Hz. Consequently, the touch control circuit 24 may alternate between a fully scanned frame and a partially scanned frame at a 1:1 ratio. In the partially scanned frame, the touch control circuit 24 may activate analog front-ends coupled to the priority areas A52 and A54 while deactivating analog front-ends coupled to the remaining area. For example, the touch control circuit 24 may activate analog front-ends AFEL14 to AFEL16 and AFER13 to AFER15 while deactivating analog front-ends AFEL1 to AFEL13, AFEL17 to AFEL36, AFER1 to AFER12, and AFER16 to AFER36.

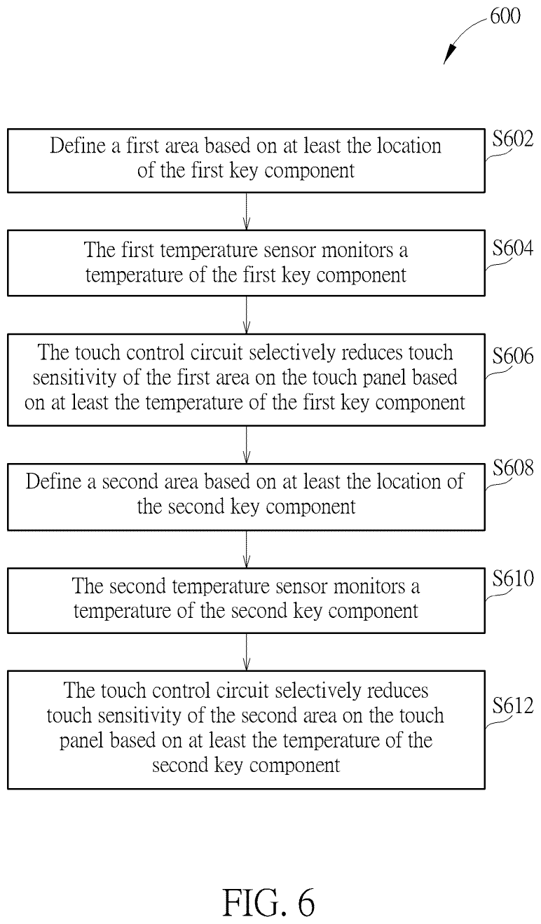

FIG. 6 is a flowchart of a method 600 of controlling the touch sensitivity of the touch device 2, according to another embodiment of the invention. The method 600 includes Steps S602 to S612 to control the touch sensitivity of different areas on the touch panel 1 based on the temperatures of key components. Any reasonable step change or adjustment is within the scope of the present disclosure. Steps S602 to S612 are detailed as follows:
Step S602: Define a first area based on at least the location of a first key component;
Step S604: The first temperature sensor monitors a temperature of the first key component;
Step S606: The touch control circuit 24 selectively reduces touch sensitivity of the first area on the touch panel 1 based on at least the temperature of the first key component;
Step S608: Define a second area based on at least the location of a second key component;
Step S610: The second temperature sensor monitors a temperature of the second key component;
Step S612: The touch control circuit 24 selectively reduces touch sensitivity of the second area on the touch panel 1 based on at least the temperature of the second key component.

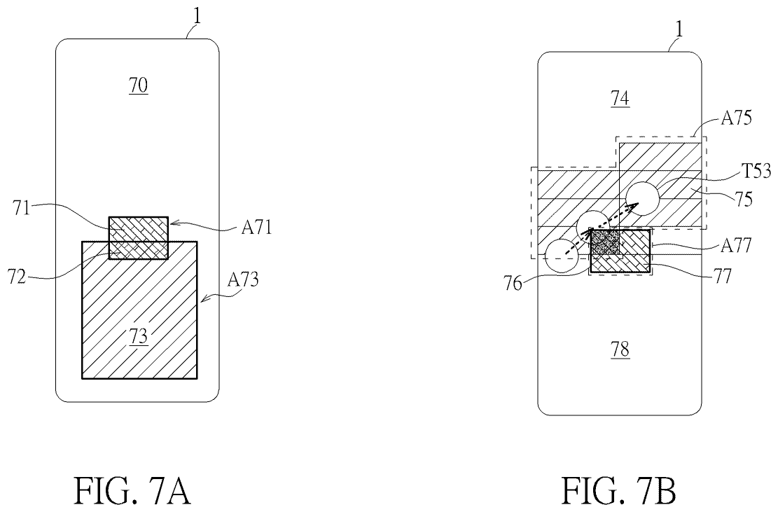

The method 600 is now explained with reference to FIGS. 2 and 7A. FIG. 7A shows a schematic diagram of the method 600 for use on the touch device 2. The touch control circuit 24 defines a power-saving area A71 based on the dimension and the location of the CPU 21 (S602). The dimension of the power-saving area A71 may encompass either the entire CPU 21 or a portion of the CPU 21. The temperature sensor 26 continuously monitors the temperature of the CPU 21 and relays the temperature of the CPU 21 to the touch control circuit 24 (S604). The touch control circuit 24 selectively reduces touch sensitivity of the power-saving area A71 based on at least the temperature of the CPU 21 (S606). If the level of the temperature of the CPU 21 is less than a temperature threshold, the touch sensitivity of the power-saving area A71 may remain unchanged. Conversely, if the level of the temperature of the CPU 21 exceeds the temperature threshold, the amount of reduction in the touch sensitivity of the power-saving area A71 may depend on at least the level of the temperature of the CPU 21.

In some embodiments, the amount of reduction is threshold-based. If the level of the temperature of the CPU 21 exceeds the temperature threshold, the touch control circuit 24 may apply a first amount of reduction in the touch sensitivity to the power-saving area A71. If the level of the temperature of the CPU 21 exceeds a higher temperature threshold, the touch control circuit 24 may apply a more aggressive amount of reduction in the touch sensitivity to the power-saving area A71. In other embodiments, the amount of reduction is proportionally scaled. Instead of discrete thresholds, the reduction in the touch sensitivity is calculated continuously. The amount of reduction scales proportionally to the difference between the level of the temperature of the CPU 21 and the base threshold, enabling smoother adjustment of the touch sensitivity.

The method 600 may further adopt a hierarchical sensitivity management mechanism based on the temperatures of multiple key components. The touch device may create dedicated power-saving areas for each key component. The key components may be a CPU, battery, control circuit, or other components potentially affected by the overheat condition. In the embodiments, the touch control circuit 24 further defines a power-saving area A73 based on the dimension and the location of a battery (S608). The dimension of the power-saving area A73 may encompass either the entire battery or a portion of the battery. A battery temperature sensor is disposed at the battery to continuously monitor the temperature of the battery and relays the temperature of the battery to the touch control circuit 24 (S610). The touch control circuit 24 selectively reduces touch sensitivity of the power-saving area A73 based on the temperature of the battery (S612). If the level of the temperature of the battery is less than a temperature threshold, the touch sensitivity of the power-saving area A73 may remain unchanged. Conversely, if the level of the temperature of the battery exceeds the temperature threshold, the amount of reduction in the touch sensitivity of the power-saving area A73 may depend on at least the level of the temperature of the battery. The amount of reduction may be determined using the approaches similar for the CPU 21.

The power-saving area A71 may be either separated from or overlapping with the power-saving area A73. In some embodiments, the power-saving area A73 may be separated from the power-saving area A71. In such cases, the touch sensitivity of each power-saving area is independently controlled by the temperature of the associated key component. Thus, the amount of reduction in the touch sensitivity of the power-saving area A73 depends on the level of the temperature of the second key component. A higher level of the temperature of the battery corresponds to a higher reduction in the touch sensitivity of the power-saving area A73.

In other embodiments, the power-saving area A71 and the power-saving area A73 have an overlapping area 72. In other words, the power-saving area A71 may be divided into a non-overlapping area 71 and the overlapping area 72, and the power-saving area A73 may be divided into a non-overlapping area 73 and the overlapping area 72. In such cases, the amount of reduction in the touch sensitivity of the non-overlapping area 71 depends on the level of the temperature of the CPU 21. The amount of reduction in the touch sensitivity of the non-overlapping area 73 depends on the level of the temperature of the battery. The amount of reduction in the touch sensitivity of the overlapping area 72 depends on the level of the temperature of the CPU 21 and the level of the temperature of the battery. A higher level of the temperature of the battery corresponds to higher reductions in the touch sensitivity of the overlapping area 72 and the non-overlapping area 73. A high level of the temperature of the battery enables the overlapping area 72 to have a smaller reduction in touch sensitivity than the non-overlapping area 73. For example, if both the levels of the temperatures of the CPU 21 and battery exceed the temperature threshold, the non-overlapping areas 71 and 73 may be scanned at a scan rate S1, and the overlapping area may be scanned at a scan rate S2, the scan rate S1 being higher than scan rate S2. Further, the remaining area 70 outside the non-overlapping areas 71 to 73 may be scanned at a scan rate S0, the scan rate S0 being higher than scan rate S1.

The method 600 mitigates the risk of excessive heat buildup in the power-saving areas, preventing operating temperature from exceeding safe thresholds, protecting the key components from potential damage or degradation, and maintaining long-term component reliability and lifespan of the touch device.

Although the embodiment in FIG. 7A utilizes only two levels of touch sensitivity, those skilled in the art would recognize that additional levels of touch sensitivity can be implemented on the touch device 2 based on similar principles.

The hierarchical sensitivity management may be applied to another method 800 that combines the methods 400 and 600. The method 800 includes Steps S802 to S812 to control the touch sensitivity of different areas on the touch panel 1 based on the locations of touch inputs and the temperature of key component. Any reasonable step change or adjustment is within the scope of the present disclosure. Steps S802 to S812 are detailed as follows:
Step S802: The touch control circuit 24 determines a location of a touch event on the touch panel 1;
Step S804: The touch control circuit 24 defines a first area on the touch panel 1 based on the location of a touch event, the location of a touch event being in the second area;
Step S806: The touch control circuit 24 reduces touch sensitivity of a second area on the touch panel 1 outside the first area;
Step S808: Define a third area based on at least the location of a key component;
Step S810: The first temperature sensor monitors a temperature of the key component;
Step S812: The touch control circuit 24 selectively reduces touch sensitivity of the third area on the touch panel 1 based on at least the temperature of the key component.

The method 800 is now explained with reference to FIGS. 2 and 7B. FIG. 7B shows a schematic diagram of the method 800 for use on the touch device 2. FIG. 7B illustrates a case similar to the rightmost schematic diagram in FIG. 5, where the location T53 of the touch event is detected between the blocks RB14 and RB15 (S802). The touch control circuit 24 defines the priority area A75 based on the location T53 (S804), and applies predetermined touch sensitivity (e.g., 120 Hz scan rate) to the priority area A75. The remaining areas 74 and 78 outside the priority area A75 are defined as power-saving areas. The touch control circuit 24 reduces the touch sensitivity of the power-saving areas from the predetermined touch sensitivity by a predetermined amount of reduction (e.g., 60 Hz) (S806), and applies the reduced touch sensitivity (e.g., 60 Hz scan rate) to the power-saving areas 74 and 78.

Further, the touch control circuit 24 defines a power-saving area A77 based on the dimension and the location of the CPU 21 (S808). The temperature sensor 26 actively monitors the temperature of the CPU 21 and passes the temperature of the CPU 21 to the touch control circuit 24 (S810). In response, the touch control circuit 24 selectively reduces the touch sensitivity of the power-saving area A77 based on at least the temperature of the CPU 21 (S812). If the level of the temperature of the CPU 21 is less than a temperature threshold, the touch sensitivity of the power-saving area A77 may remain unchanged. Conversely, if the level of the temperature of the CPU 21 exceeds the temperature threshold, the amount of reduction in the touch sensitivity of the power-saving area A77 may depend on at least the level of the temperature of the CPU 21.

The power-saving areas A77 may be either separated from or overlapping with the priority area A75. Likewise, the power-saving area A77 may be either separated from or overlapping with the power-saving areas 74 and 78.

In some embodiments, the power-saving area A77 may be separated from the priority area 75. In such cases, the touch sensitivity of power-saving area A77 is independently controlled by the temperature of the CPU 21, while the touch sensitivity of the priority area A75 is independently controlled by the location of the touch event. The amount of reduction in the touch sensitivity of the power-saving area A77 depends on the level of the temperature of the CPU 21. A higher level of the temperature of the CPU 21 corresponds to a higher reduction in the touch sensitivity of the power-saving area A77. For example, the touch control circuit 24 may apply the predetermined touch sensitivity (120 Hz scan rate) to the priority area A75 and to the power-saving area A77 if the temperature of the CPU 21 is less than a temperature threshold. However, if the temperature of the CPU 21 exceeds the temperature threshold, the touch control circuit 24 may apply the reduced touch sensitivity (60 Hz scan rate) to the power-saving area A77.

In some embodiments, the power-saving area A77 may be separated from the power-saving areas 74 and 78. In such cases, the touch sensitivity of power-saving area A77 is independently controlled by the temperature of the CPU 21, and the touch sensitivity of the power-saving areas 74 and 78 is independently controlled by the location of the touch event. For example, the touch control circuit 24 may apply the reduced touch sensitivity (60 Hz scan rate) to the power-saving areas 74 and 78, and to the power-saving area A77 if the temperature of the CPU 21 exceeds the temperature threshold. However, if the temperature of the CPU 21 is less than the temperature threshold, the touch control circuit 24 may apply the predetermined touch sensitivity (120 Hz scan rate) to the power-saving area A77.

In some embodiments, the power-saving area A77 and the priority area A75 have an overlapping area 76, while the power-saving area A77 and the power-saving area 78 have an overlapping area 77. In other words, the priority area A75 may be divided into a non-overlapping area 75 and the overlapping area 76, the power-saving area 78 may be divided into the overlapping area 77 and the power-saving area 78 excluding the overlapping area 77, and the power-saving area A77 may be divided into the overlapping areas 76 and 77.

The touch sensitivity of the non-overlapping area 75 may be the predetermined touch sensitivity (120 Hz scan rate), while the touch sensitivity of the power-saving area 78 excluding the overlapping area 77 may be the reduced touch sensitivity (60 Hz scan rate).

The amount of reduction in the touch sensitivity of the overlapping area 76 may depend on the level of the temperature of the CPU 21 and the predetermined touch sensitivity. For example, the touch control circuit 24 may apply the predetermined touch sensitivity (120 Hz scan rate) to the non-overlapping area 75 and to the overlapping area 76 if the temperature of the CPU 21 is less than the temperature threshold. However, if the temperature of the CPU 21 exceeds the temperature threshold, the touch control circuit 24 may apply the reduced touch sensitivity (60 Hz scan rate) to the overlapping area 76.

The amount of reduction in the touch sensitivity of the overlapping area 77 may depend on the level of the temperature of the CPU 21 and the reduced touch sensitivity. For example, the touch control circuit 24 may apply the reduced touch sensitivity (60 Hz scan rate) to the power-saving area 78 excluding the overlapping area 77 and to the overlapping area 77 if the temperature of the CPU 21 is less than the temperature threshold. However, if the temperature of the CPU 21 exceeds the temperature threshold, the touch control circuit 24 may apply a second reduced touch sensitivity (e.g., 30 Hz scan rate) to the overlapping area 77. The second reduced touch sensitivity may be less than the reduced touch sensitivity.

The higher level of the temperature of the CPU 21 corresponds to higher reductions in the touch sensitivity of the overlapping areas 76 and 77. A high level of the temperature of the CPU 21 enables the overlapping area 76 to have a smaller reduction in touch sensitivity than the overlapping area 77. Accordingly, if the temperature of the CPU 21 exceeds the temperature threshold, the touch control circuit 24 may apply the reduced touch sensitivity (60 Hz scan rate) to the overlapping area 76, and apply the second reduced touch sensitivity (e.g., 30 Hz scan rate) to the overlapping area 77. Since the reduction in the touch sensitivity of the overlapping area 76 from the predetermined touch sensitivity to the reduced touch sensitivity is 60 Hz (120−60), the reduction in the touch sensitivity of the overlapping area 77 from the predetermined touch sensitivity to the second reduced touch sensitivity is 90 Hz (120−30), the overlapping area 76 has a smaller reduction in touch sensitivity than the overlapping area 77 (60 Hz<90 Hz).

Although the embodiment in FIG. 7B utilizes only three levels of touch sensitivity, those skilled in the art would recognize that other number of levels of touch sensitivity can be implemented on the touch device 2 based on similar principles.

In some embodiments, if the touch control circuit 24 further anticipates that a next location of the touch event will occur in the priority area A75 in FIG. 7B, the touch sensitivity of the priority area A75 remains at the predetermined touch sensitivity (120 Hz scan rate). In such cases, the power-saving area A77 and the priority area A53 have the overlapping area 76. The touch control circuit 24 may determine the touch sensitivity of the overlapping area 76 and remaining areas based on the similar principle as discussed in the preceding paragraphs.

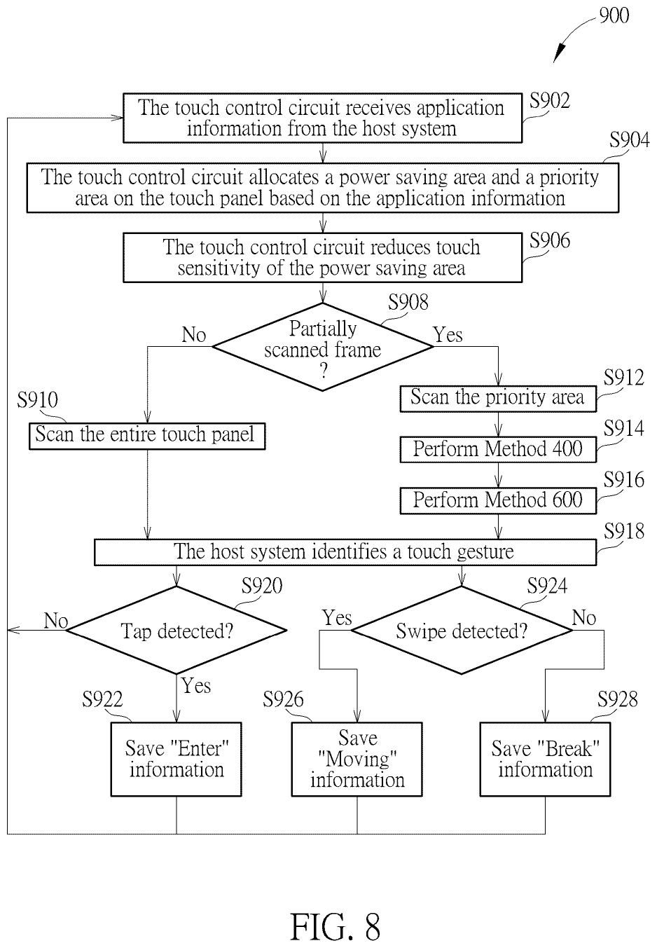

FIG. 8 is a flowchart of a method 900 of controlling the touch sensitivity of the 2, according to another embodiment of the invention. The method 900 includes Steps S902 to S928 to control the touch sensitivity of different areas on the touch panel 1, thereby enabling an adaptive touch sensitivity scheme. Any reasonable step change or adjustment is within the scope of the present disclosure. Steps S902 to S928 are detailed as follows:
Step S902: The touch control circuit 24 receives application information from the host system 20;
Step S904: The touch control circuit 24 allocates a power-saving area and a priority area on the touch panel 1 based on the application information;
Step S906: The touch control circuit 24 reduces touch sensitivity of the power-saving area;
Step S908: The touch control circuit 24 determines if the current frame is a partially scanned frame? if so, proceed to Step S912; if not, proceed to Step S910;
Step S910: The touch control circuit 24 scans the entire touch panel 1;
Step S912: The touch control circuit 24 scans the normal area;
Step S914: Perform the method 400;
Step S916: Perform the method 600;
Step S918: The host system 20 identifies a touch gesture;
Step S920: Determine if a tap is detected; if so, proceed to Step S922; if not, return to Step S902;
Step S922: Save “Enter” information; proceed to Step S902;
Step S924: Determine if a swipe is detected; if so, proceed to Step S926; if not, return to Step S928;
Step S926: Save “Moving” information; proceed to Step S902;
Step S928: Save “Break” information; proceed to Step S902.

The method 900 is now explained with reference to FIGS. 1A, 1B, and 2. The host system 20 is executing an application such as a video game or video-sharing application, as illustrated in FIGS. 1A and 1B. For simplicity of explanation, the video-sharing application in FIG. 1B is used in the following discussion. In Step S902, the host system 20 sends the information of the video-sharing application to the touch control circuit 24. The information of the video-sharing application may be the type or preset area arrangement of the video-sharing application. In response, the touch control circuit 24 allocates the power-saving area 11 and the priority area 12 based on the information of the video-sharing application (S904), set the touch sensitivity of the power-saving area 11 to the predetermined touch sensitivity (120 Hz scan rate), while reducing the touch sensitivity of the power-saving area 11 to 60 Hz (S906). Accordingly, the touch control circuit 24 scans the power-saving area 11 at a lower rate than the priority area 12 (60 Hz<120 Hz). The touch control circuit 24 may periodically receive either a fully scanned frame or partially scanned frame to detect a touch event. In the fully scanned frame, the entire touch panel 1 is scanned, the entire touch panel 1 including both the power-saving area 11 and the priority area 12. In the partially scanned frame, only the priority area 12 is scanned.

In Step S908, the touch control circuit 24 determines if the current receiving frame is a partially scanned frame? if so, the touch control circuit 24 scans the priority area 12 outside the power-saving area 11 based on the capacitance readings in the partially scanned frame (S912), so as to accurate determine the precise location of any touch event. Further, the touch device 2 performs the method 400 to adjust the touch sensitivity of different areas on the touch panel 1 based on the locations of the touch event (S914), and then performs the method 600 to adjust the touch sensitivity of different areas on the touch panel 1 based on the temperatures of key components (S916). After completing adjustment of the touch sensitivity of the touch panel 1, the method 900 proceeds to Step S918.

If the current receiving frame is a fully scanned frame rather than a partially scanned frame, the touch control circuit 24 scans the entire touch panel 1 (S910), then the method 900 proceeds to Step S918. In the embodiment, the touch control circuit 24 scans the priority area 12 to accurate determine the precise location of a touch event, while scanning the power-saving area 11 to determine a rough location of a touch event (or simply detects the presence of any touch event), based on the capacitance readings in the fully scanned frame.

In Step S918, the host system 20 identifies a touch gesture based on the precise location of a touch event from the priority area 12 and/or the rough location of a touch event from the power-saving area 11. The touch gesture may be a tap event or a swipe event. In Step S920, the touch control circuit 24 determines whether a tap event is detected based on touch events from the power-saving area 11 and/or the priority area 12. If a tap event is detected, the touch control circuit 24 registers “Enter” information for the tap event (S922), including a state of entering a function and/or the location of the touch event. If no tap event is detected, the method 900 returns to Step S902.

In Step S924, the touch control circuit 24 determines whether a swipe event is detected based on touch events from the priority area 12. If a swipe event is detected, the touch control circuit 24 registers “Moving” information for the swipe event (S926), including the locations of a trace of the touch event, and then the method 900 returns to Step S902. If no swipe event is detected, the touch control circuit 24 registers “Break” information for the swipe event (S928), indicating the termination of the swipe event, and then the method 900 returns to Step S902.

The embodiments of the invention disclose a hierarchical sensitivity management mechanism to dynamically adjust touch sensitivity of a touch device based on the application information, the location of touch inputs, and/or the temperature readings of key components, enhancing power efficiency while providing smooth user experience.

Those skilled in the art will readily observe that numerous modifications and alterations of the device and method may be made while retaining the teachings of the invention. Accordingly, the above disclosure should be construed as limited only by the metes and bounds of the appended claims.

1. A method of controlling touch sensitivity of a touch device, the touch device comprising a touch panel and a touch control circuit, the method comprising:
the touch control circuit determining a location of a touch event on the touch panel;
the touch control circuit defining a first area on the touch panel based on the location of the touch event, the location of the touch event being in the first area; and
the touch control circuit reducing touch sensitivity of a second area on the touch panel outside the first area.

2. The method of claim 1, wherein the touch device further comprises a key component and a temperature sensor, the temperature sensor being disposed at the key component; and
the method further comprises:
defining a third area based on at least the location of the key component, the key component being in the third area;
the temperature sensor monitoring a temperature of the key component; and
the touch control circuit selectively reducing touch sensitivity of the third area on the touch panel based on at least the temperature of the key component.

3. The method of claim 2, wherein:
the third area is outside the first area;
an amount of reduction in the touch sensitivity of the third area depends on a level of the temperature of the key component, and
a higher level of the temperature of the key component corresponds to a higher reduction in the touch sensitivity of the third area.

4. The method of claim 2, wherein:
the first area and the third area having an overlapping area; and
an amount of reduction in the touch sensitivity of the overlapping area and an amount of reduction in the touch sensitivity of the third area excluding the overlapping area depend on a level of the temperature of the key component.

5. The method of claim 4, wherein:
a higher level of the temperature of the key component corresponds to higher reductions in the touch sensitivity of the overlapping area and the third area excluding the overlapping area; and
a high level of the temperature of the key component enables the overlapping area to have a smaller reduction in touch sensitivity than the third area excluding the overlapping area.

6. The method of claim 1, wherein the touch control circuit reducing touch sensitivity of the second area on the touch panel comprises:
the touch control circuit deactivating an analog front-end coupled to the second area.

7. The method of claim 1, further comprising:
the touch control circuit anticipating a next location of the touch event on the touch panel;
the touch control circuit defining a third area on the touch panel based on the next location of the touch event, the next location of the touch event being in the third area; and
the touch control circuit increasing touch sensitivity of the third area.

8. The method of claim 7, wherein the touch control circuit increasing the touch sensitivity of the third area comprises:
the touch control circuit activating an analog front-end coupled to the third area.

9. The method of claim 1, further comprising:
the touch control circuit receiving application information from a host system;
the touch control circuit defines a third area on the touch panel based on the application information; and
the touch control circuit reducing touch sensitivity of the third area.

10. The method of claim 9, wherein the touch control circuit determining the location of the touch event on the touch panel comprises:
the touch control circuit scanning a fourth area on the touch panel outside the third area to detect the touch event.

11. The method of claim 10, further comprising:
the touch control circuit scanning the third area at a lower rate than the fourth area.

12. A method of controlling touch sensitivity of a touch device, the touch device comprising a touch panel, a touch control circuit, a first key component, and a first temperature sensor, the first temperature sensor being disposed at the first key component, the method comprising:
defining a first area based on at least the location of the first key component, the first key component being in the first area;
the first temperature sensor monitoring a temperature of the first key component; and
the touch control circuit selectively reducing touch sensitivity of the first area based on at least the temperature of the first key component.

13. The method of claim 12, wherein:
an amount of reduction in the touch sensitivity of the first area depends on at least a level of the temperature of the first key component.

14. The method of claim 12, wherein the touch device further comprises a second key component and a second temperature sensor disposed at the second key component; and
the method further comprises:
defining a second area based on at least the location of the second key component, the second key component being in the second area;
the second temperature sensor monitoring a temperature of the second key component; and
the touch control circuit selectively reducing touch sensitivity of the second area based on at least the temperature of the second key component.

15. The method of claim 14, wherein:
the second area is outside the first area;
an amount of reduction in the touch sensitivity of the second area depends on a level of the temperature of the second key component, and
a higher level of the temperature of the second key component corresponds to a higher reduction in the touch sensitivity of the second area.

16. The method of claim 14, wherein:
the first area and the second area having an overlapping area;
an amount of reduction in the touch sensitivity of the second area excluding the overlapping area depends on a level of the temperature of the second key component; and
an amount of reduction in the touch sensitivity of the overlapping area depends on a level of the temperature of the first key component and the level of the temperature of the second key component.

17. The method of claim 16, wherein:
a higher level of the temperature of the second key component corresponds to higher reductions in the touch sensitivity of the overlapping area and the second area excluding the overlapping area; and
a high level of the temperature of the first key component enables the overlapping area to have a larger reduction in touch sensitivity than the second area excluding the overlapping area.

18. The method of claim 14, further comprising:
the touch control circuit determining a location of a touch event on the touch panel; and
the touch control circuit defining a third area on the touch panel based on the location of the touch event, the location of the touch event being in the third area; and
the touch control circuit reducing touch sensitivity of a fourth area on the touch panel outside the third area.

19. The method of claim 18, wherein:
the first area and the fourth area having an overlapping area;
the touch sensitivity of the fourth area excluding the overlapping area is set by a predetermined amount of reduction;
an amount of reduction in the touch sensitivity of the first area excluding the overlapping area depends on a level of the temperature of the first key component; and
an amount of reduction in the touch sensitivity of the overlapping area depends on the level of the temperature of the first key component and the predetermined amount of reduction.

20. The method of claim 19, wherein:
a higher level of the temperature of the first key component corresponds to higher reductions in the touch sensitivity of the overlapping area and the first area excluding the overlapping area; and
a high level of the temperature of the first key component enables the overlapping area to have a larger reduction in touch sensitivity than the first area excluding the overlapping area and the fourth area excluding the overlapping area.

21. The method of claim 18, wherein:
the first area and the third area having an overlapping area;
the third area excluding the overlapping area has a predetermined touch sensitivity;
an amount of reduction in the touch sensitivity of the first area excluding the overlapping area depends on a level of the temperature of the first key component; and
an amount of reduction in the touch sensitivity of the overlapping area depends on the level of the temperature of the first key component and the predetermined touch sensitivity.

22. The method of claim 21, wherein:
a higher level of the temperature of the first key component corresponds to higher reductions in the touch sensitivity of the overlapping area and the first area excluding the overlapping area; and
a high level of the temperature of the first key component enables the overlapping area to have a smaller reduction in touch sensitivity than the first area excluding the overlapping area and the third area excluding the overlapping area.

23. The method of claim 18, further comprising:
the touch control circuit anticipating a next location of the touch event on the touch panel;
the touch control circuit defining a fifth area on the touch panel based on the next location of the touch event, the next location of the touch event being in the fifth area; and
the touch control circuit increasing touch sensitivity of the fifth area.

24. The method of claim 23, wherein:
the first area and the fifth area having an overlapping area;
the touch sensitivity of the fifth area excluding the overlapping area is set by a predetermined amount of reduction;
an amount of reduction in the touch sensitivity of the first area excluding the overlapping area depends on a level of the temperature of the first key component; and
an amount of reduction in the touch sensitivity of the overlapping area depends on the level of the temperature of the first key component and the predetermined amount of reduction.

25. The method of claim 14, further comprising:
the touch control circuit receiving application information from a host system;
the touch control circuit defines a third area on the touch panel based on the application information; and
the touch control circuit reducing touch sensitivity of the third area.

26. The method of claim 25, further comprising:
the touch control circuit scanning the third area at a lower rate than a fourth area outside the third area.

27. The method of claim 25, wherein:
the first area and the third area having an overlapping area;
an amount of reduction in the touch sensitivity of the third area excluding the overlapping area is set by a predetermined amount of reduction;
an amount of reduction in the touch sensitivity of the first area excluding the overlapping area depends on a level of the temperature of the first key component; and
an amount of reduction in the touch sensitivity of the overlapping area depends on the level of the temperature of the first key component and the predetermined amount of reduction.
